(19) United States
(12) Patent Application Publication
(10) Pub. No.: US 2016/0053949 A1
(43) Pub. Date: Feb. 25, 2016

(54) LIGHTING DEVICE FOR GENERATING WHITE LIGHT

(71) Applicant: ZUMTOBEL LIGHTING GMBH, Dornbirn (AT)

(72) Inventors: Johann ZEHETNER, Dornbirn (AT); David SCHMIDMAYR, Dornbirn (AT)

(73) Assignee: Zumtobel Lighting GMBH, Dornbirn (AT)

(21) Appl. No.: 14/782,495

(22) PCT Filed: Apr. 3, 2014
(86) PCT No.: PCT/EP2014/056677

§ 371 Date: Oct. 5, 2015

(30) Foreign Application Priority Data
Apr. 4, 2013 (DE) 20 2013 101 431.1

(51) Int. Cl. F21K 99/00; F21V 9/16

(52) U.S. Cl. CPC F21K 9/56; F21V 9/16; F21Y 2101/02

(57) ABSTRACT

A lighting device which is suitable for generating mixed light, preferably even for generating white light is disclosed. The lighting device includes a light source for emitting excitation light of a specific wavelength λ₂. At least two conversion elements are arranged one behind the other in the lighting device in the propagation direction of the excitation light. The conversion elements are used to convert the excitation light. In particular, a first conversion element is used to convert the wavelength λ₂ of a part of the excitation light and a second conversion element is used to convert the wavelength λ₂ of a part of the excitation light not converted by the first conversion element. In order to suppress an interaction between the conversion elements, the first conversion element and the second conversion element are separated from each other by a first distance.

The present invention relates to a lighting device and a method for generating mixed light, preferably for generating white light. In particular, the present invention proposes, in order to generate the mixed light, converting the light of an excitation light source in at least two conversion elements, which are arranged one behind the other in the radiating direction of the excitation light source and are spaced apart from one another, and combining the excitation light with the converted light.

A lighting device having a blue-emitting light-emitting diode (LED) as light source in which a white light is generated by partial color conversion of the blue light is known from the prior art. Some of the blue light of the LED is in particular converted by a color conversion layer, which is either applied directly to the LED or is arranged as a so-called “remote phosphor” layer at a distance from the LED. The mixing of the blue light of the LED and the light generated in the color conversion layer appears to an observer of the lighting device as white light overall.

Generally, different fluorescent dyes are used as conversion means for the color conversion layer which are excited by the blue light of the LED and thereupon each emit light of a different wavelength. One disadvantage here is that these conversion means have absorption and emission spectra having partial overlaps with respect to one another. As a result, in addition to the blue light from the LED, light which is emitted by a fluorescent dye is also absorbed by another fluorescent dye which emits in the relatively long wavelength range. This circumstance means that greater quantities of fluorescent dyes need to be used than would actually be required for the desired white light generation. In addition, modeling of the color conversion layer is also more difficult as a result.

The present invention is based on the object of improving the abovementioned prior art. In particular, an object of the present invention consists in minimizing interaction between different conversion means in a lighting device. A further object of the present invention consists in reducing the quantity of conversion means used and, as far as possible, only using the quantities necessary for the desired light generation. A further object of the present invention consists in providing a light-emitting means which has a light emission, and in particular a color perception, which is more homogeneous. Finally, an object of the present invention consists in developing a more efficient lighting device.

The abovementioned objects are achieved by the independent claims of the present invention. The dependent claims develop the core concept of the present invention in an advantageous manner.

The present invention relates to a lighting device for generating mixed light, preferably white light, said lighting device comprising: a light source for emitting excitation light of a specific wavelength, at least two conversion elements, which are arranged one behind the other in the propagation direction of the excitation light, wherein a first conversion element is configured to convert the wavelength of some of the excitation light, a second conversion element is configured to convert the wavelength of some of the excitation light which is not converted by the first conversion element, and the first conversion element and the second conversion element are separated from one another by a first distance.

Overall, the lighting device emits a light which is composed at least of the wavelength of the excitation light, the wavelength of the first converted light and the wavelength of the second converted light. For example, the excitation light can be from the ultraviolet or blue spectral range and can be mixed with light converted in the conversion elements from the yellow and/or green spectral range in order to generate the white light of the lighting device. The light source and/or the conversion elements can also generate light from different spectral ranges, depending on the desired mixed light of the lighting device, however.

The distance between the conversion elements means that a large proportion of the light whose wavelength is converted in a conversion element is subjected to total internal reflection at the light exit surface or the light entry surface for the unconverted excitation light. The reason for this is that the light converted into a different wavelength to a large extent has a changed emission direction in comparison with the remainder of the excitation light and therefore to a large extent impinges on the light exit surface, for example, at different angles than the excitation light, wherein these angles are subject to total internal reflection. For this purpose, the distance between the conversion elements is preferably filled with a material or a medium which has a lower refractive index than the material of the conversion elements, i.e. is an optically less dense medium than the conversion elements. Owing to the change in the propagation direction of the converted light, said light is output from the conversion element at a different point, to be precise in such a way that it does not enter the next conversion element. The unconverted light maintains its propagation direction to a large extent and is therefore at least to a large extent not subjected to total internal reflection at the light exit surface of a conversion element and can enter the next conversion element. Owing to the arrangement of the present invention, therefore, interaction between the different conversion elements can be minimized since primarily unconverted light is transmitted from one conversion element to the next. As a result, the conversion means which are responsible for the wavelength conversion in the conversion elements need only be used in quantities which are necessary for the desired mixed light. The consumption of materials is therefore reduced. In addition, the modeling of the individual conversion elements is simplified as a result. The resultant mixed light of the lighting device can therefore be predicted more precisely.

The distance between and thickness of the conversion elements in the propagation direction are preferably selected such that the observer is provided with a perception of the light color or the light color temperature of the mixed light which is as homogeneous as possible. Even a short distance between the conversion elements is sufficient for achieving the total internal reflection of the wavelength-converted light. Preferably, the conversion elements have predefined and planar light entry and light exit surfaces for the excitation light, with the result that the total internal reflection of the wavelength-converted light generated in the conversion elements can be predicted more easily.

Preferably, a third conversion element is configured to convert the wavelength of some of the excitation light which is not converted by the second conversion element, and the second conversion element and the third conversion element are separated from one another by a second distance.

By virtue of a mixture of at least four different wavelengths, white light having a particularly natural effect can be generated. In particular, improved adjustment of the light color temperature is possible. The three conversion elements can emit light from the yellow, green and red spectral ranges, for example. Together with, for example, blue light from the LED, the white light with a natural effect can be mixed.

Preferably, two adjacent conversion elements are separated from one another by an air gap.

Preferably, a material having a higher refractive index than air in the air gaps is selected as the material of the conversion elements. The air between the conversion elements is an optically less dense medium than the conversion elements themselves. The air gap makes it possible to bring about the above-described total internal reflection of the generated light. The consumption of materials for an arrangement with air gaps is minimal. Alternatively, however, a filler material can also be provided between two adjacent conversion elements having a lower refractive index than the refractive index of the two conversion elements in order to increase the robustness of the arrangement. The filler material can be in the form of an optical platelet, a disk, a layer, a film or the like, for example.

Preferably, each of the conversion elements is configured to convert the wavelength of the excitation light into a different wavelength, preferably of a different color, than the other conversion elements.

Owing to more different wavelengths, from preferably differently colored ranges of the light spectrum, a white light with a more natural effect can be generated, for example.

Preferably, each of the conversion elements is configured as a disk having two opposite flat sides and a lateral surface, and the conversion elements are configured and arranged in such a way that unconverted excitation light passes through all of the conversion elements successively via the flat sides.

The flat sides act as the light entry and light exit surfaces for the excitation light. Light generated in the conversion elements is subjected to total internal reflection to a large extent on the flat sides owing to the change of direction since said light experiences a change of direction during the conversion.

Preferably, the flat sides of the conversion elements are oriented at least approximately parallel to one another.

As a result, the excitation light or the light which is not converted in the conversion elements can pass through the successive conversion elements at least to a large extent without total internal reflection.

Preferably, each of the conversion elements is configured in such a way that excitation light converted thereby exits virtually completely via the lateral surfaces.

The converted light can exit in the radial direction to a large extent via the lateral surface. As a result, this converted light is deflected in such a way that it does not enter the next conversion element. Therefore, interaction between the conversion elements is minimized.

Preferably, each of the conversion elements is configured as a semicircular disk having an end side, which is provided with a mirror layer.

Light is reflected at the mirror layer, so that the light is directed and exits only on one side of the conversion elements via the semicircular lateral surfaces. Such a light-emitting means can be used effectively as a neon tube replacement, for example.

Preferably, each of the conversion elements has at least one different conversion means than the other conversion elements.

As a result, differently converted light, i.e. a different light wavelength, is generated in each conversion means. Preferably, light of a different color or color temperature is generated by each conversion element.

Preferably, each of the conversion elements is formed from a transparent thermoplastic material, preferably PMMA, and the conversion means is embedded in the transparent thermoplastic material.

Preferably, the conversion means are each luminophore and/or quantum dots.

Luminophore, such as fluorescent dyes or phosphor, for example, can be embedded in the material of the conversion elements particularly easily. The luminophore can be present in dispersed form, for example as a powder, particles or cluster, in the material of the conversion elements. Each conversion element can also be provided with an inner or outer layer, however. Each conversion element can also be provided with a film on both sides which is preferably coated on its inner side with a conversion layer which contains at least one distributed luminophore. Excitation light which impinges on luminophore particles is wavelength-converted and scattered, so that it impinges on the flat sides of the conversion element to a large extent at angles which favor total internal reflection.

Preferably, the first distance and the second distance are of equal magnitude. However, the distances can also match the wavelengths of the excitation light and/or the converted light.

Preferably, the first distance and the second distance are in a range from 1 to 10 mm.

A distance which is equal to or even greater than the wavelength of the light generated in the conversion element can be selected as the shortest distance. Since light of different wavelengths is preferably generated in the conversion elements, the first distance and the second distance can be different, as described above, for example can be as great as the respectively generated wavelengths or slightly greater.

Preferably, the lighting device furthermore has means for combining the unconverted excitation light and the light converted by the conversion elements in order to generate the mixed light, preferably white light.

For example, scattering means, such as a dispersion layer, can be used in order to achieve a homogenous perception of the mixed light which is emitted by the lighting device. Optical elements such as lenses, collimators or the like can also be used.

The present invention furthermore relates to a method for generating mixed light, preferably white light, said method having the following steps: generating excitation light of a specific wavelength, converting the wavelength of some of the excitation light by means of a first conversion element, and converting the wavelength of some of the excitation light which is not converted by the first conversion element by means of a second conversion element, wherein the conversion elements are arranged one behind the other in the propagation direction of the excitation light and are separated from one another by a first distance.

The present invention will now be described in detail with reference to the attached figures.

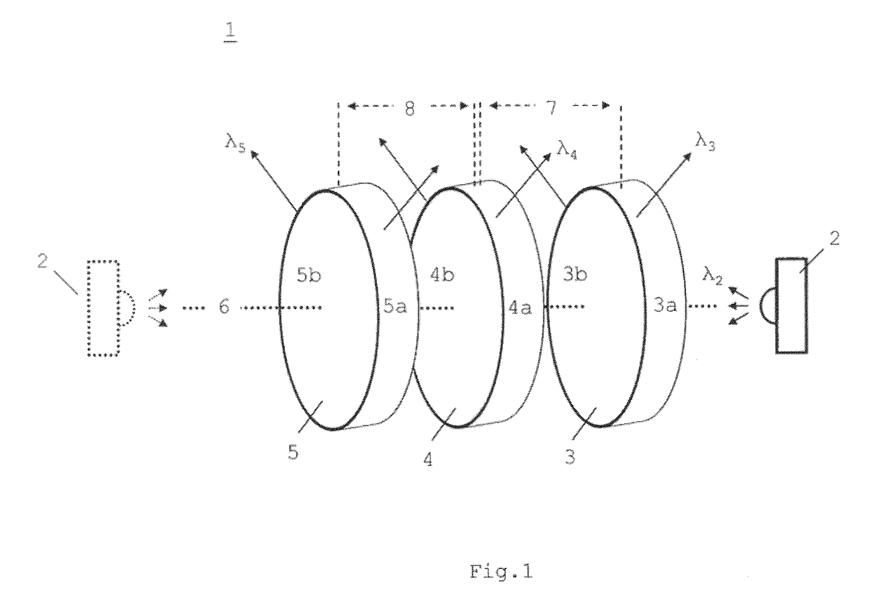

FIG. 1 shows a first embodiment of a lighting device of the present invention.

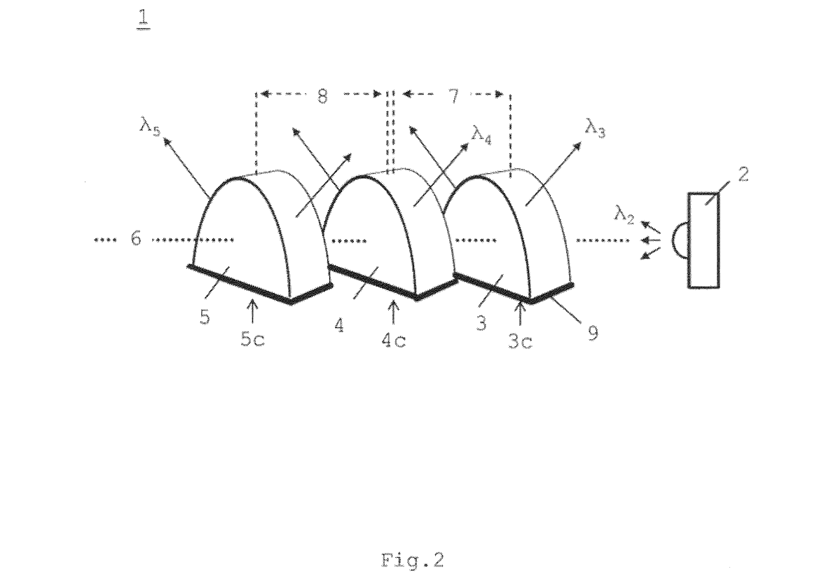

FIG. 2 shows a second embodiment of a lighting device of the present invention.

FIG. 1 shows a lighting device 1 of the present invention in accordance with a first embodiment. The lighting device 1 is configured to generate mixed light such as white light, for example. For this purpose, the lighting device 1 has a light source 2 for generating and emitting excitation light of a specific wavelength λ₂. The light source 2 used in the lighting device 1 can be, for example, an LED, an organic LED (OLED), a laser, an LED string or the like. Preferably, the light source 2 in a lighting device for generating white light is capable of emitting light from the blue or ultraviolet spectral range.

In the lighting device 1, the excitation light from the light source 2 is generally converted into secondarily generated light of different wavelengths, preferably different colors. The excitation light is then combined with the secondarily generated light in such a way that the lighting device 1 emits a mixed light, preferably a white light, of a desired color or color temperature.

In order to generate the secondary light, the lighting device 1 has at least two conversion elements 3, 4, which are arranged one behind the other in the propagation direction 6 of the excitation light. In particular, it is advantageous to arrange three conversion elements 3, 4, 5 one behind the other in the propagation direction 6 of the excitation light, as shown in FIG. 1. The excitation light from the light source 2 can in this case be oriented with respect to the conversion elements 3, 4, 5, for example by means of suitable optical elements, in such a way that it impinges on light entry surfaces of the conversion elements 3, 4, 5 at a predetermined angle only.

Each of the conversion elements 3, 4, 5 is suitable for converting the wavelength λ₂ of the light from the light source 2 into light preferably of a different wavelength λ₃, λ₄, λ₅. Preferably, the wavelengths are from the yellow, green and red spectral ranges, respectively. For this purpose, conversion means in the conversion elements 3, 4, 5 are excited by some of the excitation light and thereupon themselves emit secondary light. Within the lighting device 1 of the present invention, a first conversion element 3 first converts some of the excitation light from the light source 2 into light of a wavelength λ₃. An unconverted portion of the excitation light from the light source 2 exits to a large extent without any change of direction from the first conversion element 3 and enters the next, second conversion element 4. The second conversion element 4 then converts some of the entering light of the wavelength λ₂ into light of a wavelength λ₄. Again, an unconverted portion of the light is to a large extent supplied without any change of direction to a third conversion element 5. This supplied light of the wavelength λ₂ is converted in the third conversion element 5 partially into light of a wavelength λ₅. Finally, some of the excitation light which has not been influenced in any of the three conversion elements 3, 4, 5 and therefore has the wavelength λ₂ of the excitation light emitted by the light source 2 exits from the third color conversion element 5. The concept described is also possible with more than three conversion elements. A light source 2 can also be arranged on each side of the arrangement of the conversion elements 3, 4, 5, as indicated in FIG. 1, with the result that excitation light is radiated through the conversion elements 3, 4, 5 in opposite directions. As a result, the luminosity of the lighting device 1 can be increased.

In the lighting device 1 shown in FIG. 1, therefore, light of different wavelengths λ₂, λ₃, λ₄ and λ₅ is generated overall. These different wavelengths λ₂, λ₃, λ₄ and λ₅ are combined by suitable means in order to exit as mixed light, preferably white light, from the lighting device 1. Said means can be optical elements, such as diaphragms, lenses, scattering means or the like. It is also possible for only one light-emitting element of the lighting device 1 to surround the arrangement shown in FIG. 1 and to scatter the different light components in such a way that a homogeneous mixed light can be seen from the outside. Preferably, the individual conversion elements 3, 4, 5 are in any case so thin and arranged so close to one another that the observer is provided with a homogeneous color perception of the mixed light generated overall.

As can be seen in FIG. 1, the first conversion element 3 and the second conversion element 4 are separated from one another by a first distance 7. The second conversion element 4 and the third conversion element 5 are separated from one another by a second distance 8. The distances 7 and 8 can be of equal magnitude or can be different. The first distance 7 and the second distance 8 can correspond approximately to the wavelength λ₃ of the light generated in the first conversion element 3 or the wavelength λ₄ of the light generated in the second conversion element 4 in order to construct an arrangement which is as compact as possible. The distances 7, 8 are preferably both in a magnitude range from 0.5 to 20 mm, more preferably from 0.5 to 10 mm, further preferably still from 1 to 5 mm, however. Only air can be located between two adjacent ones of the individual conversion elements 3, 4, 5. This means that the conversion elements 3 and 4 or the conversion elements 4 and 5 are each separated from one another by an air gap. However, a material can also be arranged between said adjacent conversion elements 3, 4, 5, which material has a lower refractive index than the material of the conversion elements 3, 4, 5. The refractive indexes are in this case preferably selected such that converted light which is generated within a conversion means 3, 4, 5 experiences total internal reflection at the interface between the conversion element 3, 4, 5 and the air gap or material with a lower refractive index between the conversion elements. The conversion elements 3, 4, 5 can be adhesively bonded to one another by a layer with a lower refractive index, for example. A film, a platelet, a disk or the like consisting of a material with a lower refractive index than the material of the conversion elements 3, 4, 5 can also be arranged between two conversion elements 3, 4, 5. As a result, the entire arrangement of the conversion elements 3, 4, 5 can also be provided with additional robustness or the conversion elements can be protected.

The conversion elements 3, 4, 5 can be disks or platelets, for example, as shown in FIG. 1 and can each comprise two flat sides 3b, 4b, 5b and a lateral surface 3a, 4a, 5a. The cross section of the conversion elements 3, 4, 5 can be circular or oval, as shown in FIG. 1. During operation of the lighting device 1, excitation light from the light source 2 first impinges on that flat side 3b of the first conversion element 3 which faces the light source 2 and enters said first conversion element. The light converted in the conversion element 3 also experiences, in addition to the wavelength conversion by the conversion means, to a large extent scattering or a change of direction. Therefore, this converted light then experiences total internal reflection at the two flat sides 3b and is therefore to a large extent emitted in the radial direction via the lateral surface 3a. The unconverted light is output through the flat side 3b which is remote from the light source 2, however, since it does not interact with the conversion means and therefore to a large extent also experiences no critical change of direction, and then enters the second conversion element 4 through that flat side 4b of said second conversion element which faces the light source 2. The light converted in the second conversion element 4 experiences total internal reflection, precisely as described above, at the flat sides 4b of the second conversion element 4 and therefore exits predominantly in the radial direction of the conversion element 4 via the lateral surface 4a. The unconverted light exits from the flat side 4b which is remote from the light source 2, and enters that flat side 5b of the third conversion element 5 which faces the light source 2. In the third conversion element 5 as well, the light converted therein is subjected to total internal reflection at the flat sides 5b and to a large extent is emitted radially via the lateral surface 5a.

Owing to the fact that the respective conversion elements 3, 4, 5 are at least a short distance 7, 8 from one another, decoupling of the corresponding conversion elements 3, 4, 5 therefore takes place. Since, owing to this decoupling, the light of the wavelengths λ₃, λ₄ and λ₅ is emitted predominantly via the lateral surfaces 3a, 4a, 5a, there is hardly any interaction between the different conversion means 3, 4, 5. In addition, the mixing of the light is extremely homogeneous since the conversion elements 3, 4, 5 can be arranged close to one another. In particular when the conversion elements 3, 4, 5 are in the form of thin disks, platelets or films, for example with a thickness of approximately 1 to 10 mm, preferably 3 to 5 mm, the observer is provided with a very homogeneous color perception.

In order to convert the excitation light, each conversion element 3, 4, 5 is provided with at least one conversion means. In this case, preferably at least one conversion means is present in each conversion element 3, 4, 5 which is not contained in the other conversion means. In particular, the conversion means of the different conversion means 3, 4, 5 are intended to generate light of a different wavelength λ₃, λ₄ and λ₅. In this case, this light is preferably from differently colored spectral ranges of the spectrum. Each conversion means 3, 4, 5 therefore preferably generates light of a different color. Preferably, the wavelengths λ₃, λ₄, λ₅ are from the yellow, green and red spectral ranges, respectively. However, two or more of the wavelengths λ₃, λ₄, λ₅ can also be from the same spectral range. The conversion means can be one or more luminophores such as a phosphor or fluorescent dyes, or can be in the form of quantum dots. A luminophore can be organic or inorganic. The luminophore is preferably contained in a conversion element 3, 4, 5 in distributed form, for example in powder form, particle form or cluster form. Preferably, the at least one luminophore is embedded in the material of the conversion element 3, 4, 5. The material of the conversion elements 3, 4, 5 can be a transparent thermoplastic material such as PMMA, for example, i.e. plexiglass. Quantum dots are preferably embedded as at least one layer in the conversion elements 3, 4, 5. A plurality of layers of similar and/or different quantum dots can be stacked one above the other in this case. The quantum dots can be arranged regularly or at random. The use of quantum dots can be associated with an advantage since quantum dots can have a greater absorption range in comparison with luminophores which absorb only in a relatively limited wavelength range. As described above, the converted light is emitted from the conversion elements 3, 4, 5 preferably and to a large extent via the lateral surfaces 3a, 4a, 5a. However, a case is also possible whereby a small proportion of the converted light nevertheless also exits via the flat sides. The quantum dots can now be configured in such a way that a next conversion element 4, 5 can also convert this light, which has already been influenced by a conversion element 3, 4 situated upstream in the propagation direction of the excitation light. As a result, the efficiency of the lighting device 1 could be increased.

FIG. 2 shows a lighting device 1 of the present invention in accordance with a second embodiment. The second embodiment corresponds in terms of most features to the first embodiment. In particular, again a light source 2 and at least two, preferably three, conversion elements 3, 4, 5 are provided, which are arranged one behind the other with the corresponding intermediate distances 7, 8 in the propagation direction 6 of the light from the light source 2.

The difference in comparison with the lighting device 1 from the first embodiment consists in that the conversion elements 3, 4, 5 are not in the form of solid, i.e. round or oval, disks but are semicircular disks or platelets. As shown in FIG. 2, such semicircular conversion elements 3, 4, 5 have an end side 3c, 4c, 5c, i.e. a sectional area in comparison with a circular conversion element. The end side 3c, 4c, 5cof each of the conversion elements 3, 4, 5 can be provided with a reflecting element, for example a mirror layer or a light-reflecting film. As a result, the light exiting from the conversion elements 3, 4, 5 is directed via the lateral surface 3a, 4a, 5a. The emission angle is therefore only approximately 180° in comparison with 360° for the lighting device 1 from the first embodiment. The lighting device 1 from the second embodiment can advantageously be used as a replacement for neon tubes. It goes without saying that, instead of the disk-shaped, circular or semicircular structures of the conversion elements 3, 4, 5 which are described in the two embodiments of the present invention, other cross sections of the conversion elements 3, 4, 5 are also conceivable, such as square, rectangular, triangular, oval or the like, for example.

The present invention also comprises a corresponding method for generating mixed light or white light. For this purpose, light of a specific wavelength λ₂ is first generated, for example by a light source 2 such as an LED, OLED, a laser or the like. This excitation light is then converted partially into light of at least two different wavelengths λ₃ and λ₄ by at least one first and one second conversion element 3, 4, respectively. In this case, as described above, care is taken to ensure that light of the wavelength λ₃ does not pass from a first conversion element 3 to a large extent into a second conversion element 4. This is achieved by virtue of the conversion elements 3, 4 being arranged at a distance from one another, so that secondarily generated light is directed correspondingly by total internal reflection as it exits.

The device and the method of the present invention enable homogeneous generation of mixed light, preferably white light, without the conversion means, for example luminophores or quantum dots, needing to be used in a larger quantity than is actually necessary for the desired light generation. This is possible particularly by virtue of the fact that interaction between the different conversion elements 3, 4, 5 or the conversion means contained therein is minimized in the present invention by virtue of the conversion elements 3, 4, 5 being separated from one another by a distance, in particular a thin air gap. The present invention therefore improves the known prior art.

1. A lighting device for generating mixed light, preferably white light, said lighting device comprising:
a light source for emitting excitation light of a specific wavelength (λ₂),
at least two conversion elements, which are arranged one behind the other in the propagation direction of the excitation light, wherein
a first conversion element is configured to convert the wavelength (λ₂) of some of the excitation light,
a second conversion element is configured to convert the wavelength of some of the excitation light which is not converted by the first conversion element, and
the first conversion element and the second conversion element are separated from one another by a first distance.

2. The lighting device as claimed in claim 1, wherein a third conversion element is configured to convert the wavelength (λ₂) of some of the excitation light which is not converted by the second conversion element, and
the second conversion element and the third conversion element are separated from one another by a second distance.

3. The lighting device as claimed in claim 1, wherein two adjacent conversion elements are separated from one another by an air gap.

4. The lighting device as claimed in claim 1, wherein each of the conversion elements is configured to convert the wavelength (λ₂) of the excitation light into a different wavelength (λ₃, λ₄, λ₅), preferably of a different color, than the other conversion elements.

5. The lighting device as claimed in claim 1, wherein each of the conversion elements is configured as a disk having two opposite flat sides and a lateral surface, and
the conversion elements are configured and arranged in such a way that unconverted excitation light passes through all of the conversion elements successively via the flat sides.

6. The lighting device as claimed in claim 5, wherein the flat sides of the conversion elements are oriented at least approximately parallel to one another.

7. The lighting device as claimed in claim 5, wherein each of the conversion elements is configured in such a way that excitation light converted thereby exits virtually completely via the lateral surfaces.

8. The lighting device as claimed in claim 4, wherein each of the conversion elements is configured as a semicircular disk having an end side, which is provided with a mirror layer.

9. The lighting device as claimed in claim 1, wherein each of the conversion elements has at least one different conversion means than the other conversion elements.

10. The lighting device as claimed in claim 9, wherein each of the conversion elements is formed from a transparent thermoplastic material, preferably PMMA, and
the conversion means is embedded in the transparent thermoplastic material.

11. The lighting device as claimed in claim 9, wherein the conversion means are each luminophore and/or quantum dots.

12. The lighting device as claimed in claim 1, wherein the first distance and the second distance are of equal magnitude.

13. The lighting device as claimed in claim 1, wherein the first distance and the second distance are in a range from 1 to 10 mm.

14. The lighting device as claimed in claim 1, said lighting device furthermore comprising
means for combining the unconverted excitation light and the light converted by the conversion elements in order to generate the mixed light, preferably white light.

15. A method for generating mixed light, preferably white light, said method having the following steps:
generating excitation light of a specific wavelength (λ₂),
converting the wavelength (λ₂) of some of the excitation light by means of a first conversion element, and
converting the wavelength (λ₂) of some of the excitation light which is not converted by the first conversion element by means of a second conversion element,
wherein the conversion elements are arranged one behind the other in the propagation direction of the excitation light and are separated from one another by a first distance.
